(19) United States
(12) Patent Application Publication
(10) Pub. No.: US 2015/0102979 A1
(43) Pub. Date: Apr. 16, 2015

(54) Image Displaying Apparatus and Image Displaying Method

(71) Applicants: Kabushiki Kaisha Toshiba, Tokyo (JP); Toshiba Lifestyle Products & Services Corporation

(72) Inventor: Masaaki Ikuta, Inagi (JP)

(21) Appl. No.: 14/465,542

(22) Filed: Aug. 21, 2014

Related U.S. Application Data
(60) Provisional application No. 61/889,479, filed on Oct. 10, 2013.

(51) Int. Cl. G06F 3/14; G02F 1/1335

(52) U.S. Cl. CPC G06F 3/1446; G02F 1/133528
USPC 345/1.3

(57) ABSTRACT

According to one embodiment, an image displaying apparatus has a first and a second flat magnification display devices. These devices form a central screen. First and second mirrors are provided on a left side and a right side. First and second polarization filters alternately provided in fragmented positions in the central screen and these are different from each other in polarization direction. An image signal shaping module divides an image signal into a central and left and right regions, supplies a first image signal of the central to pixel circuits in a position of the first polarization filter, and supplies second and third image signals of the left and right to pixel circuits in a position of the second polarization filter.

### CROSS-REFERENCE TO RELATED APPLICATIONS

This application claims the benefit of U.S. Provisional Application No. 61/889,479, filed Oct. 10, 2013, the entire contents of which are incorporated herein by reference.

### FIELD

Embodiments described herein relate generally to an image displaying apparatus and an image displaying method.

### BACKGROUND

There is a liquid crystal displaying apparatus, in which first and second image signals are input, the first image signal is displayed in odd-numbered display lines, and the second image signal is displayed in even-numbered display lines. On a display screen of the liquid crystal displaying apparatus, the odd-numbered display lines and the even-numbered display lines have polarization elements of different polarization directions (first and second polarization directions), respectively.

On both sides of a display surface of the liquid crystal displaying apparatus, a left mirror and a right mirror standing from the display surface are arranged, respectively.

A viewer watches the display screen and mirror screens through a polarization filter which allows light in one of the first and second polarization directions to pass there through. The viewer can watch, for example, a first image in the odd-numbered display lines on the display screen, and a second image on the even-numbered display lines on the mirror screens. That is, the viewer can watch the image approximately twice as large as the area of the display screen in a horizontal direction.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a representative example of a structure of an image displaying apparatus according to an embodiment;

FIG. 2 is an illustration showing an example of image regions for illustrating a representative example of operations of a dividing module of FIG. 1;

FIG. 3 is an illustration showing a representative example of a structure of magnification display devices of FIG. 1;

FIG. 4 is a block diagram showing a representative example of a structure of an image displaying apparatus according to another embodiment;

FIG. 5 is a block diagram showing a representative example of a structure of an image displaying apparatus according to yet another embodiment;

FIG. 6 is an illustration showing a representative example of a structure of an image displaying apparatus according to yet another embodiment and a representative connection structure of magnification display devices;

FIG. 7 is a flowchart showing a representative example of operations of a system control module included in a signal processing system of the magnification display devices; and

FIG. 8 is a perspective view showing a representative example of an attachment structure of a mirror according to the embodiments.

### DETAILED DESCRIPTION

Various embodiments will be described hereinafter with reference to the accompanying drawings.

The embodiments provide an image displaying apparatus and an image displaying method for providing an aspect ratio of image as a ratio which enables a viewer to easily watch the image.

According to the embodiment, the apparatus comprises a first flat magnification display device and a second flat magnification display device configured to form a central screen region together with the first magnification display device. First and second mirrors are provided on a left side and a right side of the central screen region, respectively. First and second polarization filters different from each other in polarization direction are alternately provided in fragmented positions in the central screen region.

The image signal shaping module divides an image signal of a screen, supplies a first image signal of a central region to pixel circuits in a position of the first polarization filter, and supplies second and third image signals of left and right regions to pixel circuits in a position of the second polarization filter. The second and third image signals are obtained by laterally reversing and scanning the image signal to be divided.

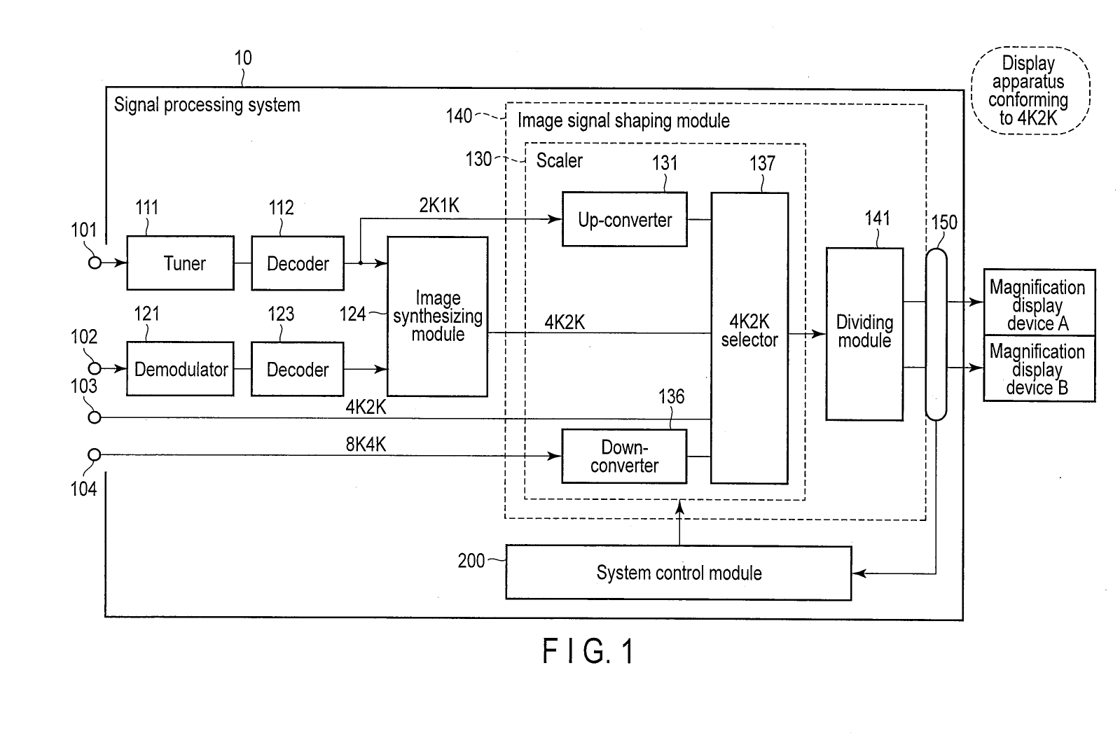

FIG. 1 shows a representative example of a structure of the image displaying apparatus according to one of the embodiments. The image displaying apparatus is, for example, a displaying apparatus conforming to 4K2K.

Of currently widespread digital television broadcast receiving apparatuses, a number of apparatuses are configured to display an image so-called 2K1K having 1920 pixels in a horizontal direction and 1080 pixels in a vertical direction. On the other hand, recently, an apparatus configured to display an image called 4K2K having 3840 pixels in the horizontal direction and 2160 pixels in the vertical direction also becomes widespread. Furthermore, an apparatus configured to display an ultrahigh-definition image called 8K4K having 7680 pixels in the horizontal direction and 4320 pixels in the vertical direction is implemented.

Thus, the apparatus according to the embodiment is improved to display image data even if image data of any resolution is input to the apparatus.

A high-frequency signal for 2K1K image data is input to an input terminal 101. Differential data of 4K2K image data and the 2K1K data is input to an input terminal 102 to convert the 2K1K data into the 4K2K data.

The high-frequency signal including the differential data input to the input terminal 102 is demodulated by a demodulator 121, and the demodulated signal is decoded by a decoder 123. The decoded differential data is input to an image synthesizing module 124 and combined with the 2K1K image data. As a result of this, the 4K2K image data can be obtained from the image synthesizing module 124.

The high-frequency signal from the input terminal 101 is channel-selected by a tuner 111 and demodulated. The demodulated signal is decoded by a decoder 112. The decoded image data is input to the image synthesizing module 124 if the differential data exists. If the differential data does not exist, the decoded image data is input to an up-converter 131 in a scaler 130 and converted to the 4K2K image data.

4K2K image data is input to an input terminal 103. 8K4K image data is input to an input terminal 104. A tuner, a decoder and the like may exist in each path of the input terminals 103 and 104.

In the scaler 130, the 4K2K image data converted by the up-converter 131 is input to a selector 137.

The 4K2K image data from the image synthesizing module 124, the 4K2K image data from the input terminal 103 and the 4K2K image data down-converted by a down-converter 136 are input to the selector 137.

The selector 137 selects image data of the 4K2K image data in accordance with a control signal from a system control module 200. The selected image data is input to a dividing module 141.

The dividing module 141 divides a screen of the image data into upper half screen data and lower half screen data. The upper half screen data is further divided into upper left screen data, upper central screen data and upper right screen data. The lower half screen data is further divided into lower left screen data, lower central screen data and lower right screen data.

Furthermore, the dividing module 141 can obtain reversed upper left screen data and reversed upper right screen data by laterally reversing each of the upper left screen data and the upper right screen data. The dividing module 141 can also obtain reversed lower left screen data and reversed lower right screen data by laterally reversing each of the lower left screen data and the lower right screen data. Screen data may be called image data, image signal or video signal.

The dividing module 141 supplies the image data (which may be called video signal or image signal) to two-dimensionally arrayed pixel circuits in a magnification display device A. At this time, the dividing module 141 can, for example, supply image data of each horizontal line of an upper central screen to pixel circuits of odd-numbered display lines of the magnification display device A, and supply image data of each horizontal line of a reversed upper left screen and a reversed upper right screen to pixel circuits of even-numbered display lines of the magnification display device A.

Moreover, the dividing module 141 can supply the image data (which may be called video signal) to two-dimensionally arrayed pixel circuits in a magnification display device B. The dividing module 141 can supply image data of each horizontal line of an lower central screen to pixel circuits of odd-numbered display lines of the magnification display device B, and supply image data of each horizontal line of a reversed lower left screen and a reversed lower right screen to pixel circuits of even-numbered display lines of the magnification display device B.

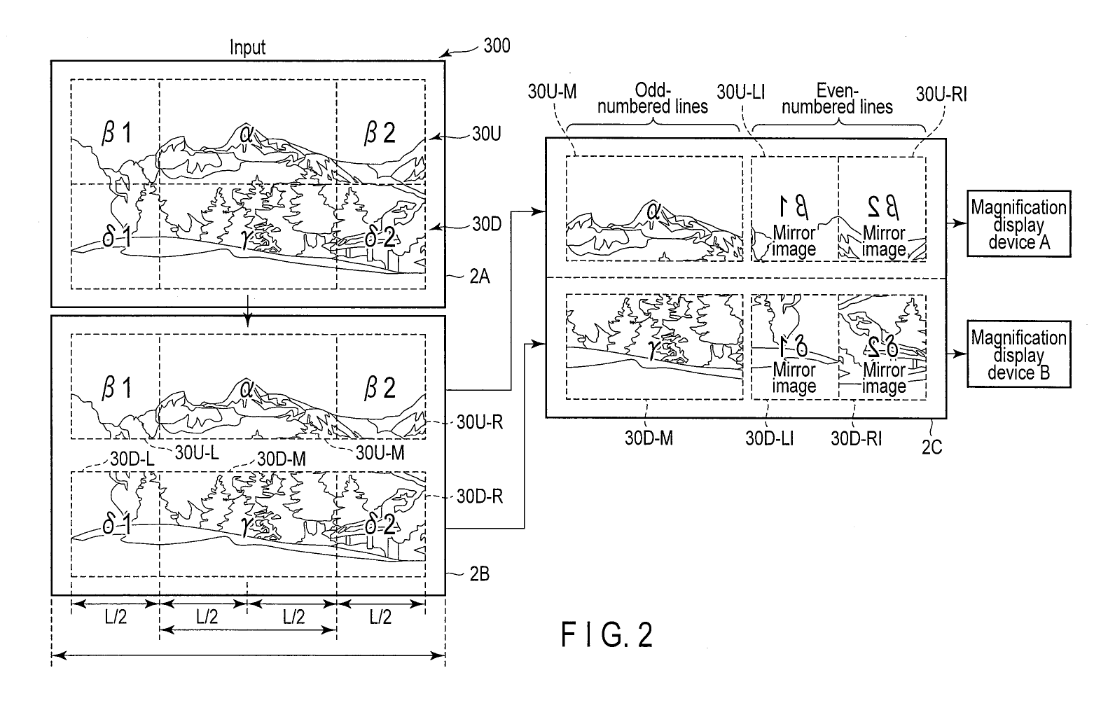

Block 2A of FIG. 2 shows an upper half screen 30U and a lower half screen 20D obtained after the screen of the 4K2K image data input to the dividing module 141 is laterally divided. Block 2B of FIG. 2 shows an upper left screen 30U-L, an upper central screen 30U-M and an upper right screen 30U-R obtained after the upper half screen is divided, and shows a lower left screen 30D-L, a lower central screen 30D-M and a lower right screen 30D-R obtained after the upper half screen is divided.

Furthermore, block 2C of FIG. 2 shows a reversed upper left screen 30U-LI and a reversed upper right screen 30U-RI obtained after the upper left screen 30U-L and the upper right screen 30U-R are laterally reversed in a scanning direction, respectively, and shows a reversed lower left screen 30D-LI and a reversed lower right screen 30D-RI obtained after the lower left screen 30D-L and the lower right screen 30D-R are laterally reversed, respectively.

When a length of the upper central screens 30U-M and 30D-M in the horizontal direction is L, a length of the upper left screen 30U-L, the upper right screen 30U-R, the lower left screen 30D-L and the lower right screen 30D-R in the horizontal direction is L/2.

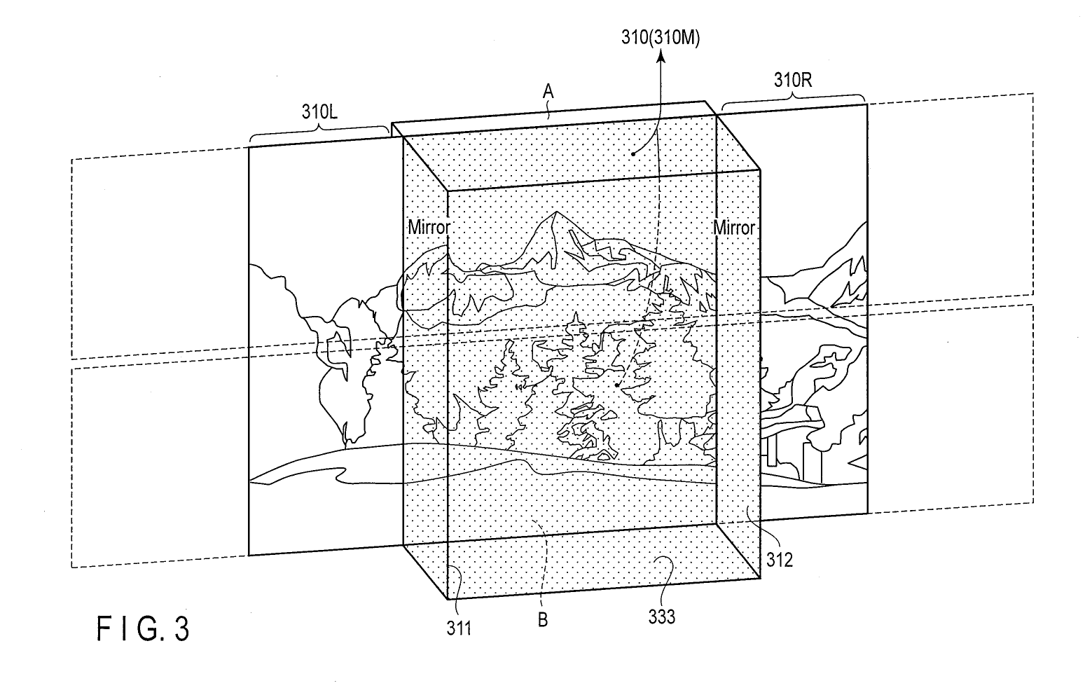

FIG. 3 shows an appearance of the magnification display device A and the magnification display device B to which the image data (which may be called video signal) that constitutes a screen shown in block 2C of FIG. 2 is input.

Each of the magnification display devices A and B has a flat panel structure and has an aspect ratio of 16:9. Each of the magnification display devices A and B includes at least a liquid crystal display panel and has an ability to display such as the 4K2K image data of this example.

A bottom edge of the magnification display device A can be connected with a top edge of the magnification display device B by a connection module (not shown). The magnification display devices A and B can form a flat display surface having an aspect ratio of 16 in width:18 in length when the devices are connected by the connection module. The flat display surface may be called a central screen region 310.

Next, a first mirror 311 and a second mirror 312 are located on a left side and a right side of the central screen region 310 such that the mirrors stand to face a front side of the screen. Mirror surfaces of the first and second mirrors 311 and 312 face a side of the central screen region 310.

Furthermore, a polarization filter 333 is arranged between edges of the first and second mirrors 311 and 312 to be opposed to and parallel to the central screen region 310 with an interval.

A relationship between polarization directions in the central screen region 310 formed of the display surface of the magnification display devices A and B, and a polarization direction of the polarization filter 333 will be described.

Polarization directions of lines of pixels in the central screen region 310 are different in the odd-numbered display lines and the even-numbered display lines. The odd-numbered display lines and the even-numbered display lines are an example of fragmented positions.

For example, a polarization of the odd-numbered display lines is left-handed circular polarization and a polarization of the even-numbered display lines is right-handed circular polarization. The polarization of the polarization filter 333 is left-handed circular polarization. Therefore, when a viewer watches the central screen region 310 through the polarization filter 333, the viewer can watch an image 310M in the odd-numbered display lines.

In contrast, in images in the even-numbered display lines, an image in a left region is reflected on the first mirror 311, an image in a right region is reflected on the second mirror 312, and these images are reflected from the first and second mirrors 311 and 312, respectively. Accordingly, the polarization direction of the reflected light from the first and second mirrors 311 and 312 is reversed and the light becomes left-handed circularly polarized light. As a result of this, the images in the even-numbered display lines reflected on the first and second mirrors 311 and 312 pass through the polarization filter 333.

Therefore, a viewer can watch the images 310M, 310L and 310R through the polarization filter 333. That is, the viewer can watch the image in a left half of the even-numbered display lines as an image (left mirror image) 310L reflected on the mirror 311, and watch the image in a right half of the even-numbered display lines as an image (right mirror image) 310R reflected on the mirror 312.

An aspect ratio of a horizontal length to a vertical length in the entire image is 16:9. That is, the magnification display devices A and B form the flat display surface having the aspect ratio of 16 in the horizontal length:18 in the vertical length when the devices are connected by the connection module, but the aspect ratio of the entire image that the viewer watches is 16:9, which is the same as the aspect ratio of each of the magnification display devices A and B. This displaying apparatus enables the viewer to watch the magnified image having a resolution of 2K1K.

In the above-described embodiment, the magnification display devices A and B have the ability to display the 4K2K image data.

In another embodiment, magnification display devices A1 and B1 having an ability to display 8K4K image data may be used.

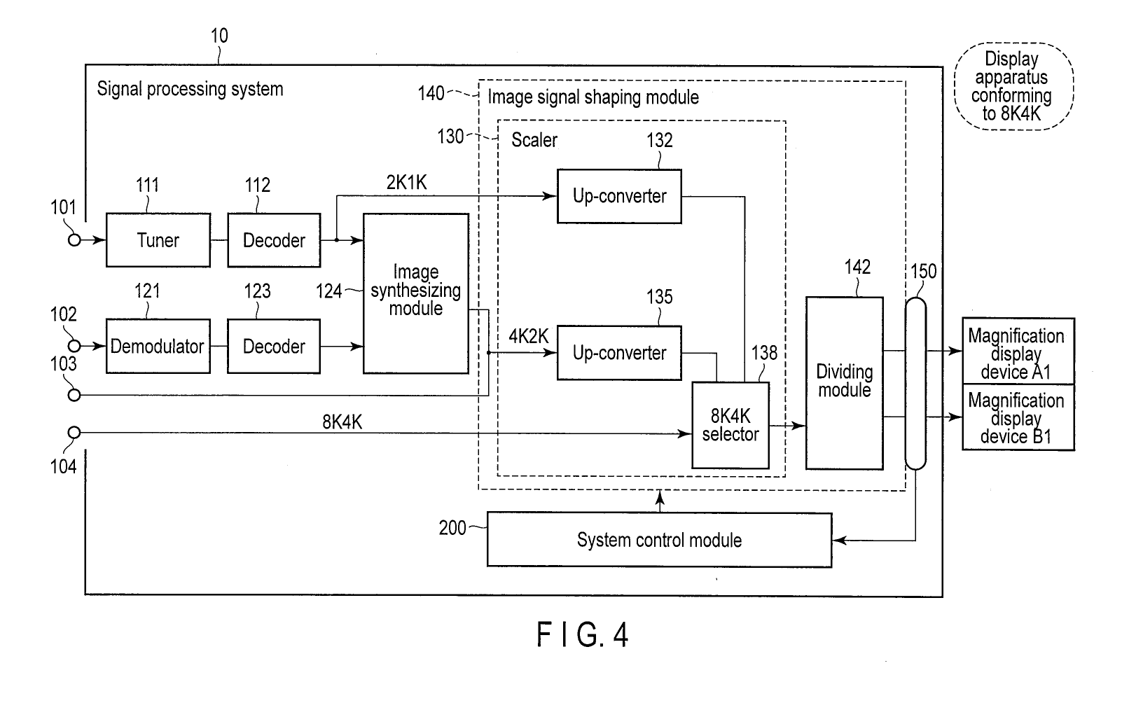

FIG. 4 shows an embodiment in which the magnification display devices A1 and B1 having the ability to display the 8K4K image data is used. The same portions as the portions of FIG. 1 are represented by the same reference numerals.

According to this embodiment, 2K1K image data output from a decoder 112 is converted to 8K4K image data in an up-converter 132 in a scaler 130. 4K2K image data output from an image synthesizing module 124 and 4K2K image data input to an input terminal 103 are converted to 8K2K image data in an up-converter 135.

The 8K4K image data from the up-converter 132 and the up-converter 135 and 8K4K image data from an input terminal 104 are input to a 8K4K selector 138.

The 8K4K selector 138 selects image data of the 8K4K image data in accordance with a control signal from a system control module 200. The selected image data is input to a dividing module 142. Dividing processing in the dividing module 142 is the same as the processing illustrated in FIG. 2. A fundamental principle of the magnification display devices A1 and B1 is the same as the principle illustrated in FIG. 3. This displaying apparatus enables a viewer to watch a magnified image having a resolution of 4K2K.

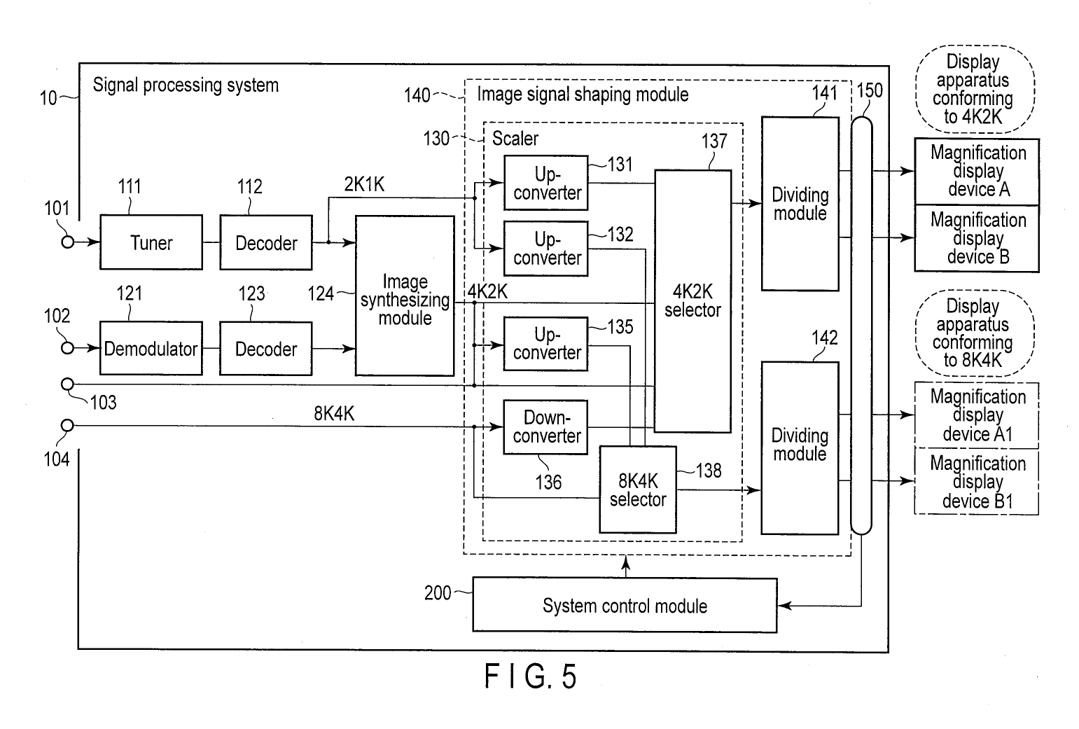

FIG. 5 shows yet another embodiment. The same portions as the portions of the embodiments of FIG. 1 and FIG. 4 are represented by the same reference numerals.

In the previous embodiments (FIG. 1 and FIG. 4), the circuit configured to obtain 4K2K image data and the circuit configured to obtain 8K4K image data are provided separately in the image signal shaping module 140. However, the circuit configured to obtain 4K2K image data and the circuit configured to obtain 8K4K image data may be provided integrally as shown in FIG. 5. Operations of a scaler and a dividing module may be selectively switched in accordance with an ability (corresponding to 4K2K image data and corresponding to 8K4K image data) of connected magnification display devices.

In the embodiment of FIG. 1, a signal processing system 10 including the tuner 111, the decoder 112, the demodulator 121, the decoder 123, the image synthesizing module 124, the image signal shaping module 140 and the system control module 200, and the display device A or B may be integrated and accommodated in a housing.

In the embodiment of FIG. 4, a signal processing system 10 including the tuner 111, the decoder 112, the demodulator 121, the decoder 123, the image synthesizing module 124, the image signal shaping module 140 and the system control module 200, and the display device A1 or B1 may be integrated and accommodated in a housing.

In the embodiment of FIG. 5, a signal processing system 10 including the tuner 111, the decoder 112, the demodulator 121, the decoder 123, the image synthesizing module 124, the image signal shaping module 140 and the system control module 200, and a display device may be integrated and accommodated in a housing.

In the above-mentioned embodiments, a method for making polarization directions of the odd-numbered display lines and the even-numbered display lines different from each other can be carried out in various manners. For example, a method using a polarization filter which allows light of 45 degrees leftward to pass there through and a polarization filter which allows light of 45 degrees rightward to pass there through, and so on can be carried out.

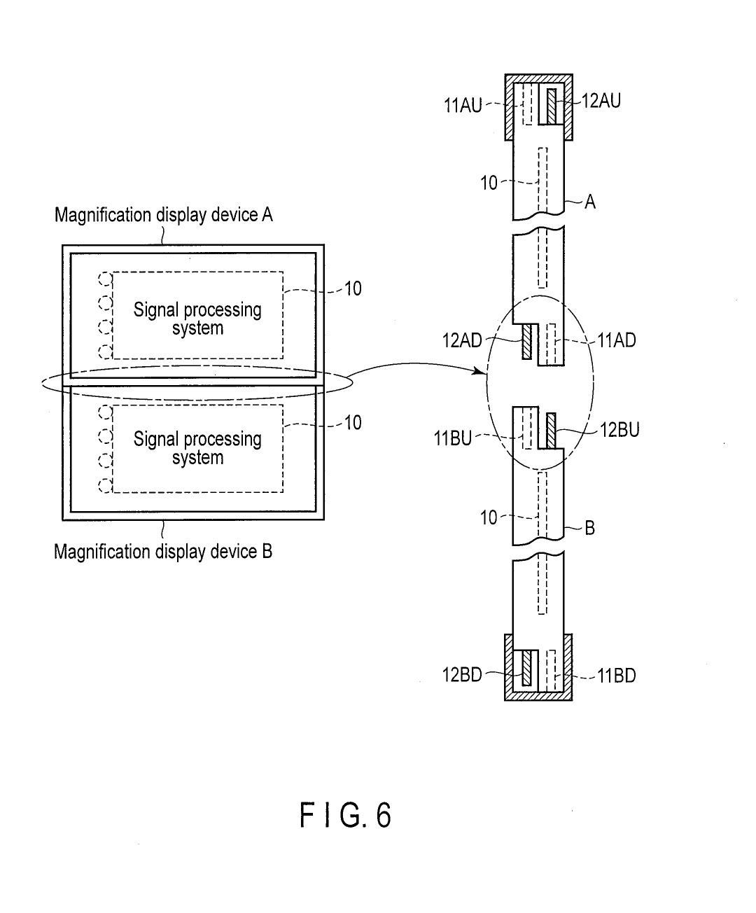

FIG. 6 is yet another embodiment in which each of a display device A and a display device B is integrated with a signal processing system 10 including a tuner 111, a decoder 112, a demodulator 121, a decoder 123, an image synthesizing module 124, an image signal shaping module 140 and a system control module 200, and accommodated in a housing.

A bottom edge of a frame of the magnification display device A comprises an insertion terminal 12AD and an acceptance terminal 11AD. A top edge of a frame of the magnification display device B comprises an insertion terminal 12BU and an acceptance terminal 11BU.

When the magnification display device A and the magnification display device B are incorporated, the insertion terminal 12AD is inserted into the acceptance terminal 11BU, and the acceptance terminal 11AD accepts the insertion terminal 12BU. If the magnification display device A and the magnification display device B are incorporated, both of the system control modules can communicate with each other via these terminals.

The magnification display device A and the magnification display device B comprise an acceptance terminal 11AU and an insertion terminal 12AU, and an insertion terminal 12BD and an acceptance terminal 11BD, respectively, such that the devices can be connected whichever device is arranged in the upper side or the lower side.

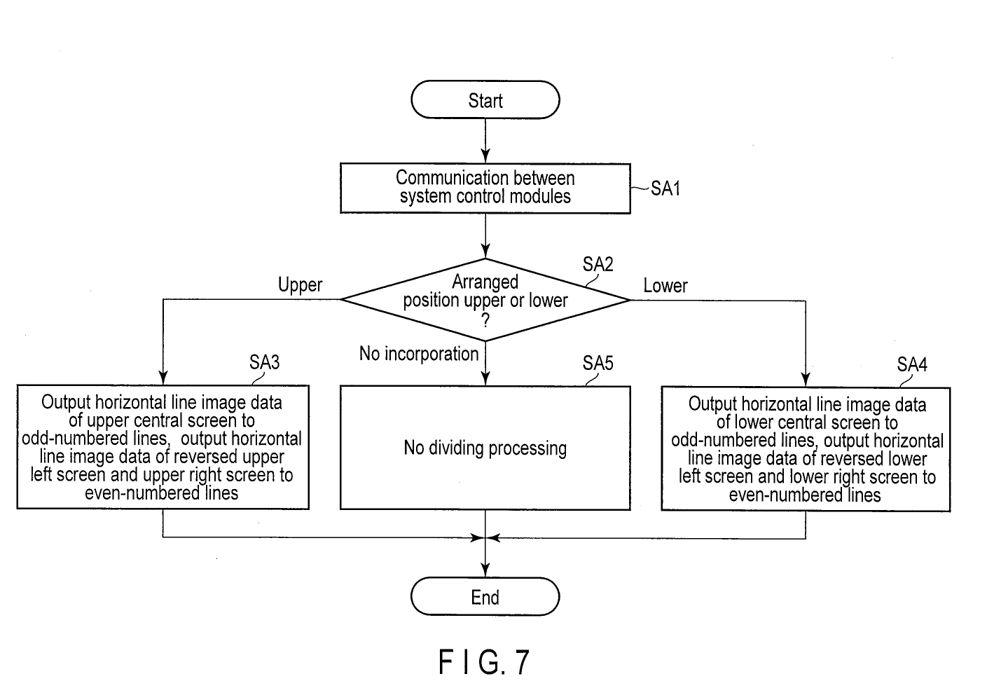

FIG. 7 shows operations of the system control module included in each of the magnification display device A and the magnification display device B when these devices are incorporated. First, the system control module in the magnification display device A and the system control module in the magnification display device B start mutual communication (step SA1). The system control modules determine whether a currently used terminal is a terminal arranged on the upper side or a terminal arranged on the lower side.

If the currently used terminal is the terminal on the lower side, the device is determined to be the magnification displaying device A (i.e., magnification display device arranged on the upper side). Conversely, if the currently used terminal is the terminal on the upper side, the device is determined to be the magnification displaying device B (i.e., magnification display device arranged on the lower side).

Based on the above determination, the signal processing device 10 in the upper housing outputs horizontal line image data (first video signal) of the upper central screen to the pixel circuits of the odd-numbered display lines of the display device, and outputs horizontal line image data (second and third video signals) of the reversed upper left screen and the reversed upper right screen to the pixel circuits of the even-numbered display lines of the display device (steps SA2 and SA3).

Furthermore, based on the above determination, the signal processing device 10 in the lower housing outputs horizontal line image data of the lower central screen to the pixel circuits of the odd-numbered display lines of the display device, and outputs horizontal line image data of the reversed lower left screen and the reversed lower right screen to the pixel circuits of the even-numbered display lines of the display device (step SA2 and SA4).

If the system control module 200 does not detect the incorporation of the display devices, the display device is determined to be used independently (steps SA2 and SA5).

In this case, image data of one screen is supplied to the pixel circuits of the odd-numbered display lines and the pixel circuits of the even-numbered display lines of the display device without the dividing processing of the dividing module 141.

In the above embodiment, the combinational structure of the magnification display device A and the magnification display device B conforming to 4K2K image data is described, but a combinational structure of the magnification display device A1 and the magnification display device B1 conforming to 8K4K image data can also be formed.

In the above description, the first flat magnification display device A, and the second flat magnification display device B having the top edge connected with the bottom edge of the flat first magnification display device A and forming the central screen region 310 together with the first magnification display device A are used. The first and second polarization filters alternately arranged in the fragmented positions in the central screen region and different from each other in polarization direction are provided.

In addition, the first and second mirrors 311 and 312 are provided to stand to face the front side of the screen on the left side and the right side of the central screen region 310.

The image signal shaping module 140 inputs the image signal to the pixel circuits of the first and second display devices. The image signal shaping module 140 supplies the first image signal to the pixel circuits in the position of the first polarization filter and supplies the second and third image signals to the pixel circuits in the position of the second polarization filter. The second and third image signals are laterally reversed and scanned signals.

In the above operations, the dividing module 141 supplies the first image signals to the magnification display devices A and B. At this time, for example, the dividing module 141 supplies the first image signals (image data of each horizontal line) of the upper central screen and the lower central screen to the pixel circuits of the odd-numbered display lines of the magnification display devices A and B, and supplies the second and third signals (image data of each horizontal line) which constitute the reversed upper left screen, the reversed upper right screen, the reversed lower left screen and the reversed lower right screen to the pixel circuits of the even-numbered display lines of the magnification display devices A and B.

In the above description, the polarization filters can be configured and modified in various manners. In the above description, the image data (first video signal) of each horizontal line of the upper central screen and the lower central screen is supplied to the pixel circuits of the odd-numbered display lines of the magnification display devices A and B, and the second and third image signals (image data of each horizontal line) which constitute the reversed upper left screen, the reversed upper right screen, the reversed lower left screen and the reversed lower right screen to the pixel circuits of the even-numbered display lines of the magnification display devices A and B.

However, the above supplying method can be modified in various manners in accordance with the structure of the polarization filters. The polarization filters different in the odd-numbered display lines and the even-numbered display lines are described, but the polarization directions of the polarization filter may be alternately different in fragmented positions (or regions). The fragmented positions may include a plurality of horizontal lines. Alternatively, each of the fragmented positions may correspond to a minute two-dimensional region including a plurality of pixel circuits. The plural fragmented positions may be formed of two-dimensionally arrayed minute regions. In the fragmented positions in which the first and second polarization filters are alternately provided, a position of the first polarization filter may be a first column line in a vertical scanning direction, and a position of the second polarization filter may be a second column line in the vertical scanning direction.

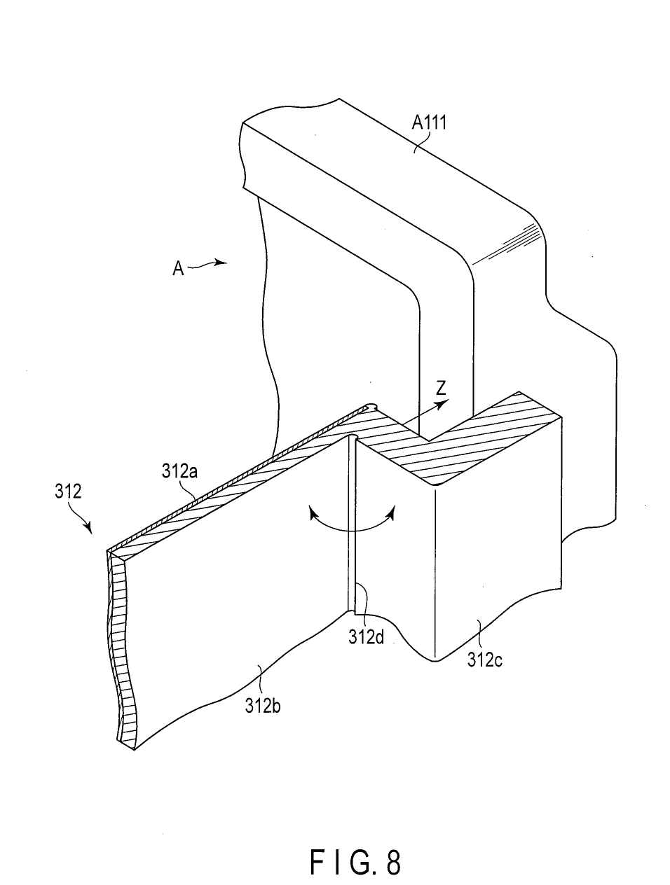

FIG. 8 shows an example of a structure for attaching the second mirror 312 on the right side to a frame A111 of the magnification display device A. The second mirror 312 comprises a mirror surface material 312a and a synthetic resin base module 312b to which the mirror surface material 312a is bonded. The base module 312b is integrated with an attachment module 312c having an L-shaped cross section. The attachment module 312c is thicker than the base module 312b.

The attachment module 312c can be pressed against the frame A111 in a direction of an arrow Z and fixed by, for example, a screw or an adhesive.

A boundary between the base module 312b and the attachment module 312c has a hinge mechanism 312d. An angle between the mirror surface of the second mirror 312 and the screen of the magnification display device A can be thereby adjusted.

In the above description, terms used for the components and the blocks are mere examples. Even if these terms are replaced with “apparatus”, “device”, “block” and “module”, they are of course within the scope of the present invention.

Furthermore, even when each of the components of the claims is divided, the plural components are expressed together, or these components are combined, they are also within the scope of the present invention. Even if the claims are expressed as methods, the apparatus of the present invention is applied to the methods.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image displaying apparatus comprising:
a first flat magnification display device;
a second flat magnification display device configured to connect a top edge of the second flat magnification display device with a bottom edge of the first magnification display device and to form a central screen region together with the first magnification display device;
first and second mirrors provided on a left side and a right side of the central screen region to stand to face a front side of a screen;
first and second polarization filters alternately provided in fragmented positions in the central screen region and different from each other in polarization direction; and
an image signal shaping module configured to input an image signal to pixel circuits of the first and second magnification display devices,
wherein the image signal shaping module divides an image signal of a screen into a central region and left and right regions, supplies a first image signal of the central region to pixel circuits in a position of the first polarization filter, and supplies second and third image signals of the left and right regions to pixel circuits in a position of the second polarization filter, the second and third image signals are laterally reversed.

2. The apparatus of claim 1, wherein, when the image signal shaping module divides the image signal of the screen,
the image signal shaping module divides the image signal of the screen into an upper left screen signal, an upper central screen signal, an upper right screen signal, a lower left screen signal, a lower central screen signal and a lower right screen signal,
obtains a reversed upper left screen signal and a reversed upper right screen signal by laterally reversing the upper left screen signal and the upper right screen signal, and obtains a reversed lower left screen signal and a reversed lower right screen signal by laterally reversing the lower left screen signal and the lower right screen signal,
outputs the upper central screen image and the lower central screen signal as the first image signal, and
outputs the reversed upper left screen signal, the reversed upper right screen signal, the reversed lower left screen signal and the reversed lower right screen signal as the second and third image signals.

3. The apparatus of claim 1, wherein an aspect ratio of the central screen region formed by combining the first and second magnification display devices is 16:18, and an aspect ratio of an entire region formed by combining the central screen region and regions of images reflected from the first and second mirrors is 16:9.

4. The apparatus of claim 1, wherein, of the fragmented positions in which the first and second polarization filters are alternately provided, the position of the first polarization filter is one of odd-numbered display lines and even-numbered display lines in a horizontal scanning direction, and the position of the second polarization filter is one of the odd-numbered display lines and the even-numbered display lines in the horizontal scanning direction.

5. The apparatus of claim 1, wherein, of the fragmented positions in which the first and second polarization filters are alternately provided, the position of the first polarization filter is first plural display lines in a horizontal scanning direction, and the position of the second polarization filter is second display lines in the horizontal scanning direction different from the first plural display lines.

6. The apparatus of claim 1, wherein, of the fragmented positions in which the first and second polarization filters are alternately provided, the position of the first polarization filter is a first column line in a vertical scanning direction, and the position of the second polarization filter is a second column line in the vertical scanning direction.

7. The apparatus of claim 1, wherein, on a frame of at least the bottom edge portion of the first magnification display device and a frame of at least the top edge portion of the second magnification display device, insertion terminals and acceptance terminals which are connected when both of the devices are incorporated are provided.

8. The apparatus of claim 7, wherein
a first image signal shaping module for the first magnification display device includes a first system control module, a second image signal shaping module for the second magnification display device includes a second system control module, and
the first and second system control modules determine a positional relationship between an upper side and a lower side when the first and second magnification devices are incorporated.

9. The apparatus of claim 8, wherein the first and second system control modules control the corresponding first and second image shaping module, and determine an image signal of the divided upper side and an image signal of the lower side to be supplied to the corresponding first magnification display device and the second magnification display device.

10. An image displaying method of a displaying apparatus wherein a central screen region is formed by connecting a bottom edge of a first flat magnification display device with a top edge of a second flat magnification display device, first and second mirrors standing to face a front side of a screen are provided on a left side and a right side of the central screen region, and first and second polarization filters different from each other in polarization direction are alternately provided in fragmented positions in the central screen region, the method comprising:
dividing an image signal of a screen into a central region and left and right regions;
supplying a first image signal of the central region to pixel circuits in a position of the first polarization filter;
supplying second and third image signals of the left and right regions to pixel circuits in a position of the second polarization filter, as the second and third image signals laterally reversed and scanned.

11. The method of claim 10, wherein, when the image signal of the screen is divided, the image signal is divided into an upper left screen signal, an upper central screen signal, an upper right screen signal, a lower left screen signal, a lower central screen signal and a lower right screen signal,
a reversed upper left screen signal and a reversed upper right screen signal are obtained by laterally reversing the upper left screen signal and the upper right screen signal, and a reversed lower left screen signal and a reversed lower right screen signal are obtained by laterally reversing the lower left screen signal and the lower right screen signal;
the upper central screen image signal and the lower central screen signal are obtained as the first image signal; and
the reversed upper left screen signal, the reversed upper right screen signal, the reversed lower left screen signal and the reversed lower right screen signal are output as the second and third image signals.
